(19) United States
(12) Patent Application Publication
(10) Pub. No.: US 2025/0070698 A1
(43) Pub. Date: Feb. 27, 2025

(54) Reducing Kinematic Error

(71) Applicant: ABB Schweiz AG, Baden (CH)

(72) Inventors: Arne Wahrburg, Weiterstadt (DE); Richard Roberts, Gilching (DE); Mikael Norrlöf, Norrköping (SE); Stig Moberg, Västerås (SE)

(73) Assignee: ABB Schweiz AG, Baden (CH)

(21) Appl. No.: 18/948,884

(22) Filed: Nov. 15, 2024

Related U.S. Application Data
(63) Continuation of application No. PCT/EP2022/063355, filed on May 17, 2022.

(51) Int. Cl. H02P 21/05; B25J 9/16; H02P 21/18

(52) U.S. Cl. CPC H02P 21/05; B25J 9/1641; H02P 21/18

(57) ABSTRACT

A method includes providing a kinematic correction, outputting a first drive control signal specifying a motor speed having a first kinematic correction output based on a first parameter vector; extracting a frequency component and determining a first feedback vector; outputting to the motor a second drive control signal specifying a motor speed as a sum of the standard speed and a second kinematic correction output based on a second parameter vector; extracting a frequency component and determining a second feedback vector defining a second feedback amplitude and a second feedback phase; subtracting the first feedback vector from the second feedback vector to obtain a feedback difference vector; transforming the feedback difference vector into a difference; applying the transformation to the second feedback vector to obtain a third parameter vector; and programming the kinematic correction generator using the third parameter vector.

### CROSS-REFERENCE TO RELATED APPLICATIONS

The instant application claims priority to International Patent Application No. PCT/EP2022/063355, filed May 17, 2022, which is incorporated herein in its entirety by reference.

### FIELD OF THE DISCLOSURE

The present disclosure generally relates to methods and apparatus for reducing kinematic error when controlling the movement of a joint in a robot manipulator.

### BACKGROUND OF THE INVENTION

A robot manipulator comprises a plurality of links, which are coupled to each other, to a base or to an end effector by rotatable joints. Rotation of such a joint is driven by a motor, typically via a reduction gear. Play and inaccuracy in the manufacture of the motors and gears affects the accuracy with which the position and the speed of an end effector at the distal end of the robot arm can be controlled. Harmonic drive gears are widely used as reduction gears in robots, since they are practically play-free, but inevitable inaccuracies, such as eccentricity of a gearwheel or spline, would still cause the rotation speed of a joint to fluctuate even if its motor could be driven at a perfectly constant speed, so that the position of the joint can deviate from what one would expect based knowing the position of the motor and the transmission ratio of the reduction gear. This deviation is commonly referred to as kinematic error or transmission error.

### BRIEF SUMMARY OF THE INVENTION

The present disclosure generally describes a simple and cost-efficient way of reducing kinematic error in a robot joint. According to an aspect of the present disclosure, a method for reducing kinematic error in a j-th joint between distal and proximal portions of a manipulator, the joint having associated to it a motor mounted in one of said portions and coupled to the other one of said portions for driving rotation of the distal portion relative to the proximal portion by a reduction gear, the method comprising the steps of providing a kinematic correction generator which is programmable using a parameter vector and outputting, based on said parameter vector and a position input, a kinematic correction which is a sum of at least one sinusoid having a frequency which is a frequency of rotation of the motor or of a periodic event in the reduction gear occurring at a higher frequency than the rotation of the distal portion, or an integer multiple thereof, and an amplitude and a phase defined by said parameter vector; outputting to the motor a first drive control signal specifying a motor speed which is a sum of a standard speed and a first kinematic correction output by the kinematic correction generator based on the first parameter vector; extracting, from an evaluation signal received from the joint in response to the first drive control signal, at least one frequency component having the frequency of the at least one sinusoid, and determining a first feedback vector defining a first feedback amplitude and a first feedback phase of said frequency component; outputting to the motor a second drive control signal specifying a motor speed which is a sum of the standard speed and a second kinematic correction output by the kinematic correction generator based on the second parameter vector; extracting, from an evaluation signal received from the joint in response to the second drive control signal, a frequency component having the frequency of the at least one sinusoid, and determining a second feedback vector defining a second feedback amplitude and a second feedback phase of said frequency component; subtracting said first feedback vector from said second feedback vector to obtain a feedback difference vector; finding a transformation which transforms said feedback difference vector into a difference between second and first parameter vectors; applying the transformation to the first feedback vector to obtain a third parameter vector; and programming the kinematic correction generator using the third parameter vector.

### BRIEF DESCRIPTION OF THE SEVERAL VIEWS OF THE DRAWING(S)

FIG. 1 is a block diagram of a robotic system in accordance with the disclosure.

FIG. 2 is a perspective view of the manipulator of the system of FIG. 1.

FIG. 3 is a cross section of a harmonic drive gear in accordance with the disclosure.

FIG. 4 is a pose assumed by the manipulator while carrying out the method in accordance with the disclosure for one of its joints.

FIG. 5 is a pose assumed by the manipulator while carrying out the method in accordance with the disclosure for another of its joints.

FIGS. 6A, 6B, and 6C are charts showing vectors in accordance with the disclosure.

### DETAILED DESCRIPTION OF THE INVENTION

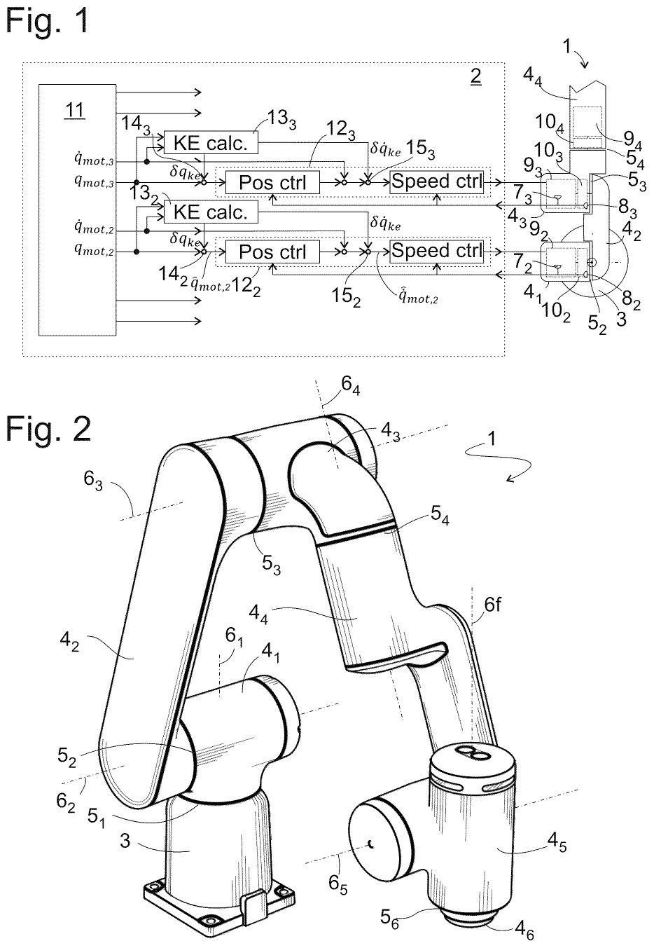

FIG. 1 is a block diagram of a robot system comprising an articulated robot arm 1 and a controller 2, in which the method of the invention can be applied. The robot arm 1, shown in more detail in FIG. 2, has a stationary base 3 fixed to a support, and a plurality of links 4ⱼ, j=1 . . . 6 rotatably connected to each other and to the base 3 by joints 5ⱼ. The joint 5₅ connecting links 4₄, 4₅ is concealed behind link 4₅. Each joint 5ⱼ enables a rotation of the link 4ⱼ on its distal side by an axis 6ⱼ. Axis 6₁ is vertical, axes 6₂ and 6₃ are horizontal; the orientations of the other axes vary. Each joint 5ⱼ has a motor associated to it for driving its rotation; the motor can be provided in a member on the proximal side of the joint and be connected to a member on the distal side thereof, or vice versa. In the robot arm of FIG. 2, joints 5₁, 5₂, 5₃ have their motors in members on their proximal side, i.e. in base 3 and links 4₁, 4₅, respectively; joints 5₃, 5₄ and 5₅ have the motors on their distal side, in links 4₃, 4₄ and 4₅, respectively.

Motors 9₂, 9₃, 9₄ associated to joints 5₂, 5₃, 5₄ and reduction gears 10₂, 10₃, 10₄ connecting these motors to links 4₂, 4₂ and 4₃, respectively, are shown in FIG. 1. Each motor 9ⱼ is provided with a current sensor 7ⱼ for measuring its winding current. Since measurement data from sensor 7ⱼ are representative of a torque applied by the motor 9ⱼ they will be referred to below as torque data τₘₒₜ. A resolver 8ⱼ is placed at each joint 5ⱼ so as to measure its rotation angle q*_{arm,j}.

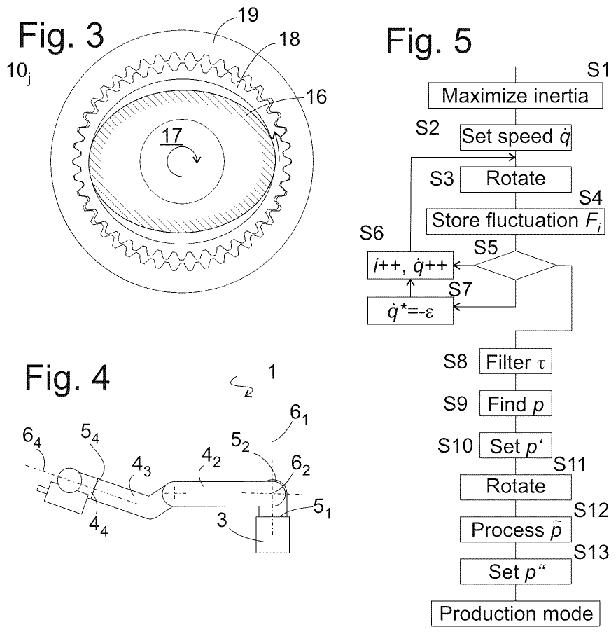

The reduction gear 10ⱼ is a harmonic gear, shown in cross section in FIG. 3, in which a wave generator 16 is rigidly coupled to an output shaft 17 of motor 9ⱼ, and is pressing teeth of a flex-spline 18 into local engagement with a circular spline 19 surrounding it. When the number of teeth of the circular spline 19 is i_{c} and that of the flexspline 18 is i_{f}, the transmission ratio of the gear 10ⱼ is

$${R}_{j} = \frac{{i}_{f} - {i}_{c}}{{i}_{f}} .$$

Since the flexspline is 18 rotating in a direction opposite to that of the wave generator 16, points of the two currently in contact will meet again after the wave generator 16 has rotated by 2πi_{f}/i_{c}, slightly less than a complete turn.

Controller 2 comprises a trajectory generator 11 for outputting, with an appropriate timing, position and speed commands to joint controllers 12ⱼ associated to a specific joint 5ⱼ as would be required for having a reference point of link 4₆ or of the tool mounted to it follow a predetermined trajectory assuming that the joints are free from kinematic error. Each joint controller 12ⱼ further has associated to it a kinematic error calculator 13ⱼ for calculating a kinematic error correction δqₖₑ, δ\dot{q}ₖₑ and adders 14ⱼ, 15ⱼ for superimposing the kinematic error correction onto the commands q_{mot,j}, \dot{q}_{mot,j} output by the trajectory generator 11, and providing corrected commands \hat{q}_{mot,j}=q_{mot,j}+δqₖₑ, \hat{\dot{q}}_{mot,j}=\dot{q}_{mot,j}+δ\dot{q}ₖₑ as will be explained in detail below.

The method of the invention can be carried out for each joint 5ⱼ at a time.

In a first step of the method of the invention (S1, see FIG. 5), the manipulator 1 is brought into a configuration where a resonance frequency of it components on the distal side of joint 5ⱼ is maximized by moving the centers of gravity of links 4ⱼ-4₆ as far away from axis 6ⱼ as possible, as shown in FIG. 4 for j=2. A counting index i is set to 1, a fluctuation reference F₀ is set to 0, and a step width Δ\dot{q} is initialized.

A rotation speed \dot{q}_{mot,j} for motor 9ⱼ is set (S2), and trajectory generator 11 controls a rotation around axis 6ⱼ at nominally constant speed by outputting angle commands q_{mot,j} to motor 9ⱼ that have a constant rate of change \dot{q}_{mot,j}.

In step 3, while the joint 5ⱼ is being rotated at the speed set in step S2, imperfections of the motor 9ⱼ and the reduction gear 10ⱼ cause the current detected by sensor 7ⱼ to fluctuate. A measure Fᵢ of this fluctuation, e.g., a standard deviation of currents measured while carrying out the rotation, is recorded (S4).

If in step S5, Fᵢ-Fᵢ₋₁ is found to be positive, and |Δ\dot{q}_{mot,j}| is above a pre-determined threshold, i is incremented and \dot{q}_{mot,j} is incremented by Δ\dot{q} in step S6, and the method returns to step S3. If Fᵢ-Fᵢ₋₁ is found to be negative, Δ\dot{q} is multiplied by a factor ε between 0 and −1 (S7) before proceeding to step S6. When successive multiplications by ε have caused Δ\dot{q} to drop below the threshold, the amount F of fluctuation has reached a maximum, and it can be assumed that \dot{q}_{mot,j} is the critical speed of joint 5ⱼ.

Each time step S3 is executed, a series of motor positions and associated torque data Imot from sensor 7ⱼ are recorded. The last one of these series, comprising N pairs of measurement values τₘₒₜ¹, τₘₒₜ², . . . , τₘₒₜ^{N} and motor or arm positions at which these were obtained is retained for evaluation. The positions may be taken from commands q_{mot,j}¹, q_{mot,j}², . . . , q_{mot,j}^{N} of the trajectory generator, preferably they are derived from readings q_{arm,j}* from resolver 8ⱼ taken simultaneously with the torque measurement values.

Optionally, a spectral analysis of this series may be carried out in order to find out the frequency components that provide the largest contribution to the fluctuation of the torque data. Else it may simply be assumed that components which have been found to provide an important contribution in other manipulators will do so here, too.

In step S9, a sum of sinusoids Σᵢ₌₁^{M}A_{i,j} sin (kᵢq_{mot,j}+ϑ_{i,j}) of M harmonics is fitted to the N collected data points with solving b=Θp for the parameter vector p with

$$Θ = [ \begin{matrix}1 & sin ( {k}_{1} {q}_{mot , j}^{1} ) cos ( {k}_{1} {q}_{mot , j}^{1} ) & … & sin ( {k}_{M} {q}_{mot , j}^{1} ) cos ( {k}_{M} {q}_{mot , j}^{1} ) \\ ⋮ & ⋮ & & ⋮ \\ 1 & sin ( {k}_{1} {q}_{mot , j}^{N} ) cos ( {k}_{1} {q}_{mot , j}^{N} ) & … & sin ( {k}_{M} {q}_{mot , j}^{N} ) cos ( {k}_{M} {q}_{mot , j}^{N} )\end{matrix} ] \qquad ( 1 )$$

$$b = [ \begin{matrix}{τ}_{mot}^{1} \\ ⋮ \\ {τ}_{mot}^{N}\end{matrix} ] ∈ {ℝ}^{N}$$

$$and$$

$$p = [ \begin{matrix}C \\ {A}_{S , 1} \\ {A}_{C , 1} \\ ⋮ \\ {A}_{S , M} \\ {A}_{C , M}\end{matrix} ] ∈ {ℝ}^{1 + 2 M} ,$$

wherein kᵢ, i=1, . . . , M refers to the important frequency components mentioned above. If it is known that the most important frequency components are e.g. at twice the rotation frequency of the motor 9ⱼ and at 2*i_{f}/i_{c} times the rotation frequency of the motor 9ⱼ, we may set M=2, k₂=2 for the second harmonic of the motor rotation and k₁=2i_{f}/i_{c} for a nearby contribution of the harmonic gear. The parameter vector p, referred to below as the feedback parameter vector, contains a sine and cosine value A_{S,i}, A_{C,i} for each frequency component (which is equivalent to characterizing the component by an amplitude and a phase) and a constant offset C to handle a constant bias.

If the joint is subject to position-dependent gravity load (as is the case for joint 5₂ in FIG. 4), the torque data can be subjected to high-pass filtering (S8) prior to their evaluation in step S9. The transmission ratio of gear 10ⱼ being Rⱼ, the filtering threshold frequency should be between the rotation frequency of motor 9ⱼ and Rⱼ times this frequency.

In step S10, a second parameter vector

$${p}^{′} = [ \begin{matrix}{C}^{′} \\ {A}_{S , 1}^{′} \\ {A}_{C , 1}^{′} \\ ⋮ \\ {A}_{S , M}^{′} \\ {A}_{C , M}^{′}\end{matrix} ]$$

is arbitrarily defined, and is

transmitted to kinematic error calculator 13ⱼ, thereby enabling it to output a kinematic error compensation

$$δ {q}_{k e} = {\sum }_{i = 1}^{M} {A}_{i , j}^{′} sin ( {k}_{i} {q}_{mot , j} + {ϑ}_{i , j}^{′} ) \qquad ( 2 )$$

$$δ {\dot{q}}_{k e} = {\sum }_{i = 1}^{M} {k}_{i} {A}_{i , j}^{′} cos ( {k}_{i} {q}_{mot , j} + {ϑ}_{i , j}^{′} ) ,$$

wherein A′_{i,j}=\sqrt{A′_{S,i}²+A′_{C,i}²}and ϑ′_{i,j}=tan⁻¹(A′_{C,i}/A′_{S,i}), when q_{mot,j} is the motor angle output by trajectory generator 11. In step S11, another rotation around axis 6ⱼ is carried out, in which the motor receives commands q_{mot,j}, \dot{q}_{mot,j} to which compensations δqₖₑ(q_{mot,j}), δ\dot{q}ₖₑ(q_{mot,j}) have been added in adders 14ⱼ, 15ⱼ. Torque data b′=(τ′ₘₒₜ¹, τ′ₘₒₜ², . . . , τ′ₘₒₜ^{N})^{T} resulting therefrom are collected, and are evaluated (S12) as described above in steps S8, S9 for torque data b, whereby a second feedback parameter vector \tilde{p}=[\tilde{C} Ã_{S,1} Ã_{C,1} . . . Ã_{C,;}]^{T} is obtained.

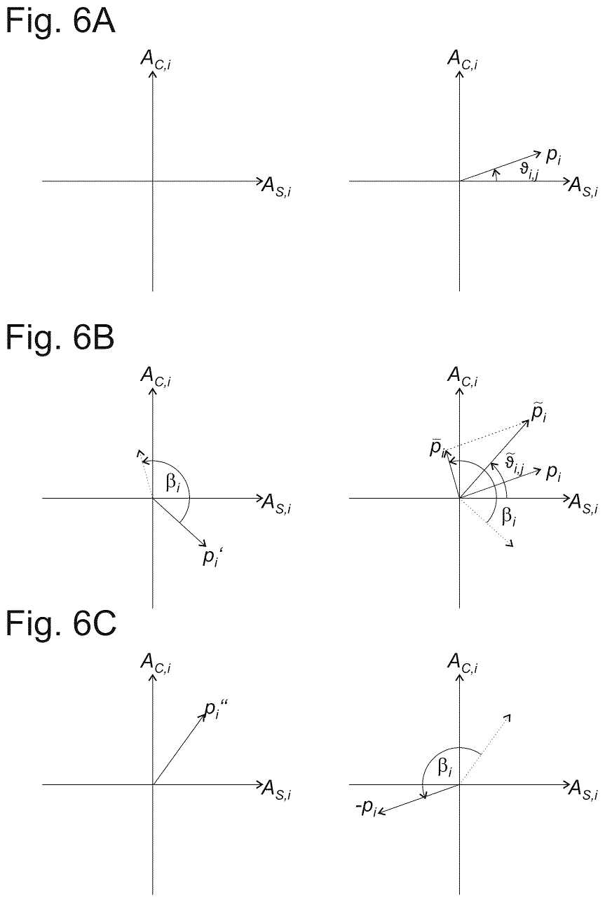

Processing of these data (S12) is described referring to FIG. 6. FIG. 6 is a series of diagrams showing components A_{S,i}, A_{C,i} of an arbitrary frequency component kᵢ of a parameter vector. It should be understood that this two-dimensional representation is chosen only because more than two dimensions are difficult to illustrate graphically; i.e. what the diagrams show are in fact two-dimensional projections of multi-dimensional vectors. The left-hand part of each diagram shows in solid lines components of a parameter vector used by kinematic error calculator 13ⱼ to calculate the kinematic error compensation according to eq. (2); the right-hand part shows components of the parameter vector extracted from the torque data using eq. (1).

FIG. 6A illustrates the case of step S3 where the parameter vector used by the kinematic error calculator 13ⱼ is 0, but a vector p≠0 (of which components pᵢ are shown) is derived from the torque data in step S9.

FIG. 6B illustrates components p′ᵢ=[A′_{S,i}, A′_{C,i}] of the second parameter vector p′ and \tilde{p}ᵢ=[Ã_{S,i}, Ã_{C,i}] of the second feedback vector \tilde{p} resulting from it. If there wasn't the underlying imperfection that yields the first feedback vector p≠0 for a parameter vector 0, the second parameter vector p′ could be expected to produce an ideal feedback vector p̅=[Ā_{S,i}, Ā_{C,i}]=\tilde{p}−p where p̅ᵢ is related to p′ᵢ by an angle βᵢ between the two and a gain factor

$${g}_{i} = \sqrt{{\overline{A}}_{S , i}^{2} + {\overline{A}}_{C , i}^{2}} / \sqrt{{A}_{S , i}^{′2} + {A}_{C , i}^{′2}} ,$$

where Ā_{S,i}=Ã_{S,i}−A_{S,i} and Ā_{C,i}=Ã_{C,i}−A_{C,i}. I.e. βᵢ and gᵢ are parameters of a transformation that would transform components p′ᵢ of FIG. 6B into components p̅ᵢ. With these parameters known, it is possible to find a parameter vector p″ which, by the same transformation, is transformed into −p (FIG. 6C).

This parameter vector p″ is transmitted to kinematic error calculator 13ⱼ in step S13, so as to cause it, in the future, to calculate the kinematic error correction by inserting components of p″ in eq. (2).

This process is carried out for one joint after the other. When afterwards (S14) the controller 2 enters production mode with all kinematic error calculator 13ⱼ, applying the correction of eq. 2, speed fluctuations of the reference point due to imperfections of the reduction gears 10ⱼ are substantially cancelled.

The object of the present invention is to provide simple and cost-efficient way of reducing kinematic error in a robot joint.

According to an aspect of the present invention, this object is achieved by a method for reducing kinematic error in a j-th joint between distal and proximal portions of a manipulator, the joint having associated to it a motor mounted in one of said portions and coupled to the other one of said portions for driving rotation of the distal portion relative to the proximal portion by a reduction gear, the method comprising the steps of:
providing a kinematic correction generator which is programmable using a parameter vector and outputting, based on said parameter vector and a position input, a kinematic correction which is a sum of at least one sinusoid having
a frequency which is a frequency of rotation of the motor or of a periodic event in the reduction gear occurring at a higher frequency than the rotation of the distal portion, or an integer multiple thereof, and
an amplitude and a phase defined by said parameter vector,
outputting to the motor a first drive control signal specifying a motor speed which is a sum of a standard speed and a first kinematic correction output by the kinematic correction generator based on the first parameter vector;
extracting, from an evaluation signal received from the joint in response to the first drive control signal, at least one frequency component having the frequency of the at least one sinusoid, and determining a first feedback vector defining a first feedback amplitude and a first feedback phase of said frequency component,
outputting to the motor a second drive control signal specifying a motor speed which is a sum of the standard speed and a second kinematic correction output by the kinematic correction generator based on the second parameter vector;
extracting, from an evaluation signal received from the joint in response to the second drive control signal, a frequency component having the frequency of the at least one sinusoid, and determining a second feedback vector defining a second feedback amplitude and a second feedback phase of said frequency component,
subtracting said first feedback vector from said second feedback vector to obtain a feedback difference vector;
finding a transformation which transforms said feedback difference vector into a difference between second and first parameter vectors,
applying the transformation to the first feedback vector to obtain a third parameter vector,
programming the kinematic correction generator using the third parameter vector.

In a preferred embodiment, the above processing is simplified by choosing the first parameter vector to define an amplitude of the at least one sinusoid to be zero. The sinusoid can be defined as a weighted sum of sine and cosine functions; in that case weighting coefficients of both would have to be zero. Alternatively it can be defined as a sine or cosine function having an amplitude and a phase; when the amplitude is zero here, the phase has no physical significance and can be assigned any value.

In order to facilitate processing of the evaluation signal, the standard speed should be constant or, at least, substantially constant.

The standard speed can be regarded as substantially constant if effects of external forces acting on the distal portion on the evaluation signal, due e.g. to the weight of the distal portion driving or opposing the movement of the distal portion, can be suppressed by high-pass filtering the evaluation signal. Due to the reduction gear, the speed of rotation of the motor will be much higher than that of the joint. Since the external forces are usually proportional to a sinusoid of the joint angle, these can be suppressed by setting a cutoff frequency lower than the motor frequency and higher than the motor frequency multiplied with the reduction ratio of the reduction gear.

The standard speed or a harmonic thereof should correspond to a resonance frequency of the manipulator, i.e. the motor frequency needed to drive the distal portion at the standard speed or a harmonic thereof, preferably the second harmonic, should equal the resonance frequency.

This speed doesn't have no be known in advance; rather, finding it can be a preparatory step of the method of the invention. Specifically, in a preparatory stage of the method, the distal portion can be controlled to rotate at various speeds, and the speed where vibration of the manipulator is strongest can be chosen as the standard speed.

It can be assumed that a robot controller is trying to find the critical speed when a same movement of the distal portion is carried out repeatedly at different speeds, the speed changing from one iteration to the next, and the speed difference between successive iterations occasionally changing its sign, and/or the amount of the speed difference decreasing on each change of sign.

Since the moment of inertia of the manipulator or of parts of it is variable depending on configuration, and for the method of the invention it is desirable to have a low critical speed, the distal portion can be controlled to assume a configuration in which its moment of inertia is maximized, and which should be maintained while the method is carried out.

The evaluation signal can represent any measurable quantity that is susceptible to fluctuate due to an imperfection of the motor or the reduction gear. It could be the speed of rotation of the distal member itself, as measured e.g. by a dedicated angle sensor built into the manipulator for measuring rotation of the joint on a downstream side of the reduction gear, a laser scanner or other optical sensing means for observing the manipulator from outside, or the like. According to a preferred embodiment, the evaluation signal is representative of motor torque, since suitable sensing circuitry exists in many legacy manipulators, so that when the method of the invention makes use of this circuitry, it can be implemented in such manipulators by a control software update.

When a harmonic drive gear is used as a reduction gear, its wave generator will usually be connected to the motor output shaft, whereas its flex-spline is connected to the output shaft of the reduction gear, and the circular spline is fixed. When the number of teeth of the circular spline is i_{c}, and that of the flexspline is i_{f}, the orientation of the wave generator relative to the flexspline becomes identical after every i_{f}/i_{c} rotations of the wave generator ant the motor output shaft, causing contributions to the kinematic error at m i_{f}/i_{c} times the rotation frequency of the motor, where m is a small integer. Since is i_{f} is slightly smaller than i_{c}, contributions of the flex-spline and the circular spline to the kinematic error tend to have frequencies that differ slightly from those of the motor and the wave generator.

Experiments have shown that for most harmonic drive gears the most important contribution of the flex-spline and the circular spline is at is 2i_{f}/i_{c} times the rotation frequency.

In order to take account of various sources contributing to the kinematic error, in most practical cases the kinematic correction will be a sum of two or more sinusoids.

The kinematic correction generator can best be provided by programming a processor to operate as such, in particular by updating a control processor of a legacy manipulator to enable it to operate as the kinematic correction generator, or by updating the third parameter vector whenever maintenance or repair work has been carried out at the corresponding joint.

According to another aspect of the present invention, the object is achieved by a robotic system comprising a manipulator having a proximal portion, a distal portion, a joint connecting said proximal and distal portions and a motor for driving rotation of the joint, and a controller connected to the motor and adapted to carry out at least steps b. to i. of the method described above.

According to a further aspect, the object is achieved by a computer software product comprising a plurality of instructions which, when executed by a processor, cause the processor to carry out at least steps b. to i. of the method described above.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for reducing kinematic error in a joint between a distal portion and a proximal portion of a manipulator, the joint having associated to it a motor mounted in one of said portions and coupled to the other one of said portions for driving rotation of the distal portion relative to the proximal portion by a reduction gear, the method comprising:
providing a kinematic correction generator that is programmable using a parameter vector and outputting, based on said parameter vector and a position input, a kinematic correction, which is a sum of at least one sinusoid having a frequency which is a frequency of rotation of the motor or of a periodic event in the reduction gear occurring at a higher frequency than the rotation of the distal portion, or an integer multiple thereof, and an amplitude and a phase defined by said parameter vector;
outputting to the motor a first drive control signal specifying a motor speed which is a sum of a standard speed and a first kinematic correction output by the kinematic correction generator based on a first parameter vector;
extracting, from an evaluation signal received from the joint in response to the first drive control signal, at least one frequency component having the frequency of the at least one sinusoid, and determining a first feedback vector defining a first feedback amplitude and a first feedback phase of said frequency component;
outputting to the motor a second drive control signal specifying a motor speed which is a sum of the standard speed and a second kinematic correction output by the kinematic correction generator based on a second parameter vector;
extracting, from an evaluation signal received from the joint in response to the second drive control signal, a frequency component having the frequency of the at least one sinusoid, and determining a second feedback vector defining a second feedback amplitude and a second feedback phase of said frequency component;
subtracting said first feedback vector from said second feedback vector to obtain a feedback difference vector;
finding a transformation which transforms said feedback difference vector into a difference between second and first parameter vectors;
applying the transformation to the second feedback vector to obtain a third parameter vector; and
programming the kinematic correction generator using the third parameter vector.

2. The method of claim 1, wherein the amplitude defined by said first parameter vector is zero.

3. The method of claim 1, wherein the standard speed is a constant speed.

4. The method of claim 1, wherein extracting the frequency component having the frequency of the at least one sinusoid comprises high-pass filtering the evaluation signal, a cutoff frequency optionally being lower than the motor frequency and higher than the motor frequency multiplied with the reduction ratio of the reduction gear.

5. The method of claim 1, wherein the standard speed or a harmonic thereof corresponds to a resonance frequency of the manipulator.

6. The method of claim 5, further comprising at least one of:
controlling the distal portion to rotate at various speeds and choosing as the standard speed the one of those various speeds where vibration of the manipulator is strongest; and/or
controlling the distal portion to assume a configuration where its moment of inertia is maximized.

7. The method of claim 1, wherein the evaluation signal is representative of motor torque.

8. The method of claim 1, wherein the reduction gear is a harmonic gear having a circular spline with i_{c} teeth and a flex-spline with i_{f} teeth, and the frequency of the at least one sinusoid is i_{f}/i_{c} times the rotation frequency of the motor or an integer multiple thereof.

9. The method of claim 8, wherein the integer multiple is 2i_{f}/i_{c} times the rotation frequency.

10. The method of claim 1, wherein the kinematic correction is a sum of two or more sinusoids.

11. The method of claim 1, wherein the step of providing the kinematic correction generator comprises programming a processor to operate as the kinematic correction generator.

12. A robotic system, comprising:
a manipulator having a proximal portion, a distal portion, a joint connecting said proximal and distal portions, and a motor for driving rotation of the joint; and
a controller connected to the motor and adapted to carry out:
providing a kinematic correction generator that is programmable using a parameter vector and outputting, based on said parameter vector and a position input, a kinematic correction, which is a sum of at least one sinusoid having a frequency which is a frequency of rotation of the motor or of a periodic event in the reduction gear occurring at a higher frequency than the rotation of the distal portion, or an integer multiple thereof, and an amplitude and a phase defined by said parameter vector;
outputting to the motor a first drive control signal specifying a motor speed which is a sum of a standard speed and a first kinematic correction output by the kinematic correction generator based on a first parameter vector;
extracting, from an evaluation signal received from the joint in response to the first drive control signal, at least one frequency component having the frequency of the at least one sinusoid, and determining a first feedback vector defining a first feedback amplitude and a first feedback phase of said frequency component;
outputting to the motor a second drive control signal specifying a motor speed which is a sum of the standard speed and a second kinematic correction output by the kinematic correction generator based on a second parameter vector;
extracting, from an evaluation signal received from the joint in response to the second drive control signal, a frequency component having the frequency of the at least one sinusoid, and determining a second feedback vector defining a second feedback amplitude and a second feedback phase of said frequency component;
subtracting said first feedback vector from said second feedback vector to obtain a feedback difference vector;
finding a transformation which transforms said feedback difference vector into a difference between second and first parameter vectors;
applying the transformation to the second feedback vector to obtain a third parameter vector; and
programming the kinematic correction generator using the third parameter vector.
